(19) United States
(12) Patent Application Publication
(10) Pub. No.: US 2009/0158337 A1
(43) Pub. Date: Jun. 18, 2009

(54) MOSAIC VIDEO CONTENT SELECTION MECHANISM

(75) Inventors: Todd Stiers, Berkeley, CA (US); Greg LaCommare, San Ramon, CA (US); Jason Mikami, Oakland, CA (US)

Correspondence Address: Weaver Austin Villeneuve & Sampson LLP, P.O. BOX 70250, OAKLAND, CA, 94612-0250, US

(73) Assignee: MOBITV, INC., Emeryville, CA (US)

(21) Appl. No.: 11/956,188

(22) Filed: Dec. 13, 2007

(51) Int. Cl. G06F 3/00

(52) U.S. Cl. 725/44

(57) ABSTRACT

Mechanisms are provided for allowing a user to dynamically obtain program guide data and select video content in an efficient and effective manner. A guide generator is configured to obtain program guide information from multiple sources including content providers. The guide generator compiles a real-time most watched program guide by determining viewing patterns associated with various channels and video clips. Channels and video clips requested most frequently are listed first. A real-time most watched program guide including data such as program titles, times, icons, and links is then provided and displayed as needed on client devices. Potentially limitless amounts of program guide data can be provided on a client device while still allowing a user to efficiently and effectively select video content.

### DESCRIPTION OF RELATED ART

The present disclosure relates to video content selection. In some examples, the techniques of the present disclosure provide mechanisms for generating mosaic video streams for efficient video content selection.

Electronic program guides provide users with information to allow video content selection. Some electronic program guides provide hundreds or thousands of options including numerous channels and video on demand clips. However, mechanisms for sorting through the options and selecting video content are limited. Consequently, the techniques and mechanisms of the present invention provide improved mechanisms to efficiently select video content.

### Overview

Mechanisms are provided for allowing a user to dynamically select video content in an efficient and effective manner. A mosaic of video content is provided as a single channel to a user. The mosaic is provided along with a mechanism for a user to select a particular channel displayed in the mosaic. In particular examples, an overlay provided on top of the mosaic of video content provides a user navigation interface. In other examples, numeric and text based selection is also possible.

These and other features of the present invention will be presented in more detail in the following specification of the invention and the accompanying figures, which illustrate by way of example the principles of the invention.

### BRIEF DESCRIPTION OF THE DRAWINGS

The disclosure may best be understood by reference to the following description taken in conjunction with the accompanying drawings, which illustrate particular embodiments of the present invention.

FIG. 1 illustrates a particular example of a network that can use the techniques and mechanisms of the present invention.

FIG. 2 illustrates a particular example of a content delivery system.

FIG. 3 illustrates a particular example of a mosaic video stream.

FIG. 4 illustrates another particular example of a mosaic video stream.

FIG. 5 illustrates a particular example of an overlay corresponding to a mosaic video stream.

FIG. 6 illustrates a particular example of device receiving a mosaic video stream and providing an overlay.

FIG. 7 illustrates a particular example of server processing for providing a mosaic video stream.

### DESCRIPTION OF PARTICULAR EMBODIMENTS

Reference will now be made in detail to some specific examples of the invention including the best modes contemplated by the inventors for carrying out the invention. Examples of these specific embodiments are illustrated in the accompanying drawings. While the invention is described in conjunction with these specific embodiments, it will be understood that it is not intended to limit the invention to the described embodiments. On the contrary, it is intended to cover alternatives, modifications, and equivalents as may be included within the spirit and scope of the invention as defined by the appended claims.

For example, the techniques of the present invention will be described in the context of particular devices such as mobile devices. However, it should be noted that the techniques and mechanisms of the present invention can be used with a variety of devices including general computing devices. In the following description, numerous specific details are set forth in order to provide a thorough understanding of the present invention. The present invention may be practiced without some or all of these specific details. In other instances, well known process operations have not been described in detail in order not to unnecessarily obscure the present invention.

Various techniques and mechanisms of the present invention will sometimes be described in singular form for clarity. However, it should be noted that some embodiments include multiple iterations of a technique or multiple instantiations of a mechanism unless noted otherwise. For example, a processor is used in a variety of contexts. However, it will be appreciated that multiple processors can also be used while remaining within the scope of the present invention unless otherwise noted. Furthermore, the techniques and mechanisms of the present invention will sometimes describe two entities as being connected. It should be noted that a connection between two entities does not necessarily mean a direct, unimpeded connection, as a variety of other entities may reside between the two entities. For example, a processor may be connected to memory, but it will be appreciated that a variety of bridges and controllers may reside between the processor and memory. Consequently, a connection does not necessarily mean a direct, unimpeded connection unless otherwise noted.

Selecting video content on a device such as a mobile phone or a portable computing device can often be inefficient. In many instances, subscription packages provide hundreds of channels and thousands of video on demand clips. It is difficult for a user to identify interesting or exciting content. In some instances, electronic program guides can organize content by category, such as dramas, sports, or movies and provide the content in numerically ordered channel listings. In some other instances, popular programs or award winning content is flagged for a user. Electronic program guides may also be filtered. In some examples, non-family oriented programming is filtered based on user selection.

However, providing thousands of channels and video clips to a user results in a large of amount of information and choices. This information may be shown in a part of a display or condensed onto a device screen. The information may scroll automatically or may scroll after user input. In many instances, channels and video clips may be listed in numerical order or alphabetical order. In either case, it takes a tremendous amount of time to sift through content, and even after viewing the titles, a user still may have insufficient information to make an intelligent selection.

Consequently, the techniques and mechanisms of the present invention display panels of actual live feeds as a channel itself. A user can rapidly view many options at the same time. Using the live channel as a background, a lightweight menu-driven navigation system can be used to position an overlay indicator to select video content. Alternatively, numeric or text based navigation schemes could also be used. Providing a mosaic of channels in a single channel instead of merging multiple live feeds into a single display decreases complexity of a device application. Merging multiple live feeds require individual, per channel feeds of content to be delivered and processed at an end user device. Bandwidth and resource usage for delivery and processing of multiple feeds can be substantial. Less bandwidth is used for a single mosaic channel, as a mosaic channel would simply require a video feed from a single channel. The single channel could be generated by content providers, service providers, etc.

According to particular embodiments, mosaic channels include video content such as live video content, looped clip content, trailers, advertisements, etc. Mosaic channels may also include user selected live channels of both live and clip content. The live content and clip streams can be arranged into a variety of visual patterns such as grid, trees, clusters, and circular patterns on a mosaic. A wide variety of other patterns including patterns with overlapping video streams are also possible. In particular examples, mosaic channels are dynamically changing based on popularity and viewership information.

Mosaics can be displayed on a user device in an efficient and effective manner. Bandwidth and processing resources are not wasted as only a single channel needs to be delivered and processed. According to particular embodiments, a relatively lightweight client side application provides an interface for a user to navigate mosaics. In some examples, a mosaic video stream may allow navigation to another mosaic video stream. A mosaic may have an overlay that allows navigation to numerous other mosaics. In particular examples, numeric or text selection mechanisms can be provided to select channel content. For example, particular numeric or text codes can be mapped to particular streams displayed in a mosaic. In other examples, an overlay allows movement and selection of video stream display windows. Advertising can also be supported using overlays on channels. Particular windows can again be mapped to particular streams.

The mapping information may be delivered as part of a stream or may be delivered separately. According to particular embodiments, every mosaic channel has corresponding navigation engine instructions. In particular examples, the navigation engine instructions may correspond to both the channel identifier and the mosaic pattern indicating the placement of videos for the channel.

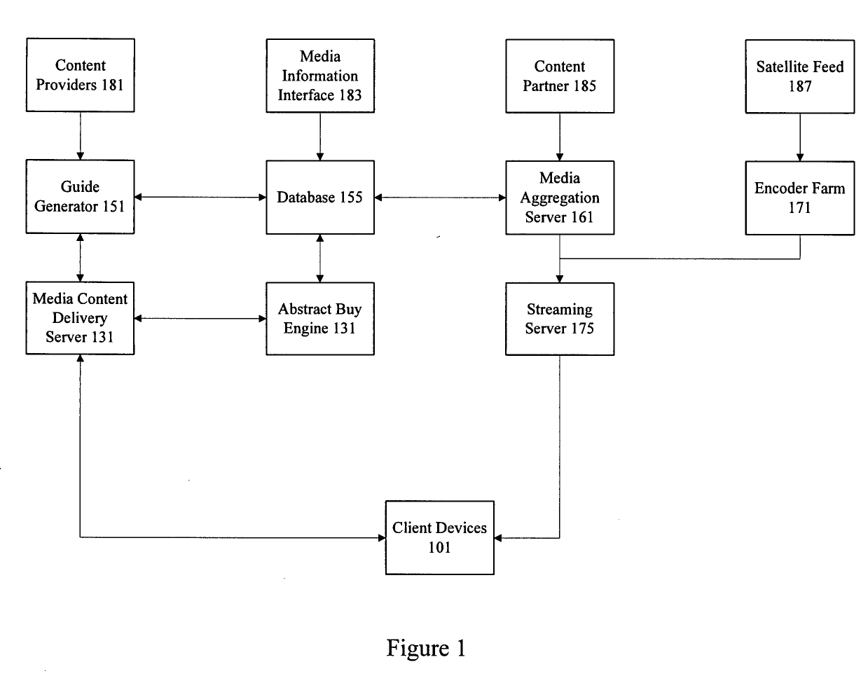

FIG. 1 is a diagrammatic representation showing one example of a network that can use the techniques of the present invention. According to various embodiments, media content is provided from a number of different sources 185. Media content may be provided from film libraries, cable companies, movie and television studios, commercial and business users, etc. and maintained at a media aggregation server 161. Any mechanism for obtaining media content from a large number of sources in order to provide the media content to mobile devices in live broadcast streams is referred to herein as a media content aggregation server. The media content aggregation server 161 may be clusters of servers located in different data centers. According to various embodiments, content provided to a media aggregation server 161 is provided in a variety of different encoding formats with numerous video and audio codecs. Media content may also be provided via satellite feed 157.

An encoder farm 171 is associated with the satellite feed 187 and can also be associated with media aggregation server 161. The encoder farm 171 can be used to process media content from satellite feed 187 as well as possibly from media aggregation server 161 into potentially numerous encoding formats. According to various embodiments, file formats include open standards MPEG-1 (ISO/IEC 11172), MPEG-2 (ISO/IEC 13818-2), MPEG-4 (ISO/IEC 14496), as well as proprietary formats QuickTime™, ActiveMovie™, and RealVideo™. Some example video codecs used to encode the files include MPEG-4, H.263, and H.264. Some example audio codecs include Qualcomm Purevoice™ (QCELP), The Adaptive Multi--Narrow Band (AMR-NB), Advanced Audio coding (AAC), and AACPlus. The media content may also be encoded to support a variety of data rates. The media content from media aggregation server 161 and encoder farm 171 is provided as live media to a streaming server 175. In one example, the streaming server is a Real Time Streaming Protocol (RTSP) server 175. Media streams are broadcast live from an RTSP server 175 to individual client devices 101. A variety of protocols can be used to send data to client devices.

Possible client devices 101 include personal digital assistants (PDAs), cellular phones, personal computing devices, personal computers etc. According to various embodiments, the client devices are connected to a cellular network run by a cellular service provider. IN other examples, the client devices are connected to an Internet Protocol (IP) network. Alternatively, the client device can be connected to a wireless local area network (WLAN) or some other wireless network. Live media streams provided over RTSP are carried and/or encapsulated on one of a variety of wireless networks.

The client devices are also connected over a wireless network to a media content delivery server 131. The media content delivery server 131 is configured to allow a client device 101 to perform functions associated with accessing live media streams. For example, the media content delivery server allows a user to create an account, perform session identifier assignment, subscribe to various channels, log on, access program guide information, obtain information about media content, etc. According to various embodiments, the media content delivery server does not deliver the actual media stream, but merely provides mechanisms for performing operations associated with accessing media. In other implementations, it is possible that the media content delivery server also provides media clips, files, and streams. The media content delivery server is associated with a guide generator 151. The guide generator 151 obtains information from disparate sources including content providers 181 and media information sources 183. The guide generator 151 provides program guides to database 155 as well as to media content delivery server 131 to provide to client devices 101.

According to various embodiments, the guide generator 151 obtains viewership information from individual client devices. In particular embodiments, the guide generation 151 compiles viewership information in real-time in order to generate a most-watched program guide listing most popular programs first and least popular programs last. The client device 101 can request program guide information and the most-watched program guide can be provided to the client device 101 to allow efficient selection of video content. According to various embodiments, guide generator 151 is connected to a media content delivery server 131 that is also associated with an abstract buy engine 141. The abstract buy engine 141 maintains subscription information associated with various client devices 101. For example, the abstract buy engine 141 tracks purchases of premium packages.

The media content delivery server 131 and the client devices 101 communicate using requests and responses. For example, the client device 101 can send a request to media content delivery server 131 for a subscription to premium content. According to various embodiments, the abstract buy engine 141 tracks the subscription request and the media content delivery server 131 provides a key to the client 101 to allow it to decode live streamed media content. Similarly, the client device 101 can send a request to a media content delivery server 131 for a most-watched program guide for its particular program package. The media content delivery server 131 obtains the guide data from the guide generator 151 and associated database 155 and provides appropriate guide information to the client device 101.

Although the various devices such as the guide generator 151, database 155, media aggregation server 161, etc. are shown as separate entities, it should be appreciated that various devices may be incorporated onto a single server. Alternatively, each device may be embodied in multiple servers or clusters of servers. According to various embodiments, the guide generator 151, database 155, media aggregation server 161, encoder farm 171, media content delivery server 131, abstract buy engine 141, and streaming server 175 are included in an entity referred to herein as a media content delivery system.

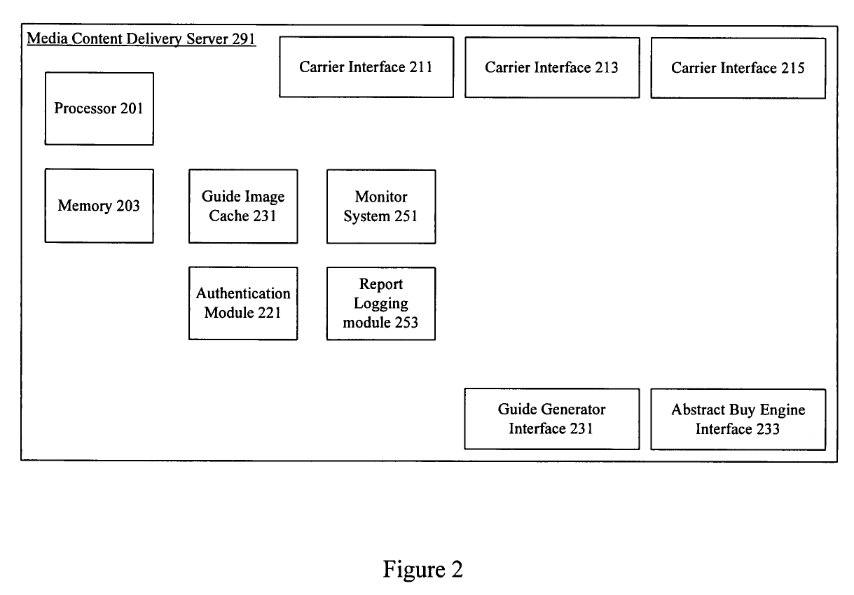

FIG. 2 is a diagrammatic representation showing one example of a media content delivery server 291. According to various embodiments, the media content delivery server 291 includes a processor 201, memory 203, and a number of interfaces. In some examples, the interfaces include a guide generator interface 241 allowing the media content delivery server 291 to obtain program guide information. The media content delivery server 291 also can include a program guide cache 231 configured to store program guide information and data associated with various channels. The media content delivery server 291 can also maintain static information such as icons and menu pages. The interfaces also include a carrier interface 211 allowing operation with mobile devices such as cellular phones operating in a particular cellular network. The carrier interface allows a carrier vending system to update subscriptions. Carrier interfaces 213 and 215 allow operation with mobile devices operating in other wireless networks. An abstract buy engine interface 243 provides communication with an abstract buy engine that maintains subscription information.

An authentication module 221 verifies the identity of mobile devices. A logging and report generation module 253 tracks mobile device requests and associated responses. A monitor system 251 allows an administrator to view usage patterns and system availability. According to various embodiments, the media content delivery server 291 handles requests and responses for media content related transactions while a separate streaming server provides the actual media streams. In some instances, a media content delivery server 291 may also have access to a streaming server or operate as a proxy for a streaming server. But in other instances, a media content delivery server 291 does not need to have any interface to a streaming server. In typical instances, however, the media content delivery server 291 also provides some media streams. The media content delivery server 291 can also be configured to provide media clips and files to a user in a manner that supplements a streaming server.

Although a particular media content delivery server 291 is described, it should be recognized that a variety of alternative configurations are possible. For example, some modules such as a report and logging module 253 and a monitor 251 may not be needed on every server. Alternatively, the modules may be implemented on another device connected to the server. In another example, the server 291 may not include an interface to an abstract buy engine and may in fact include the abstract buy engine itself. A variety of configurations are possible.

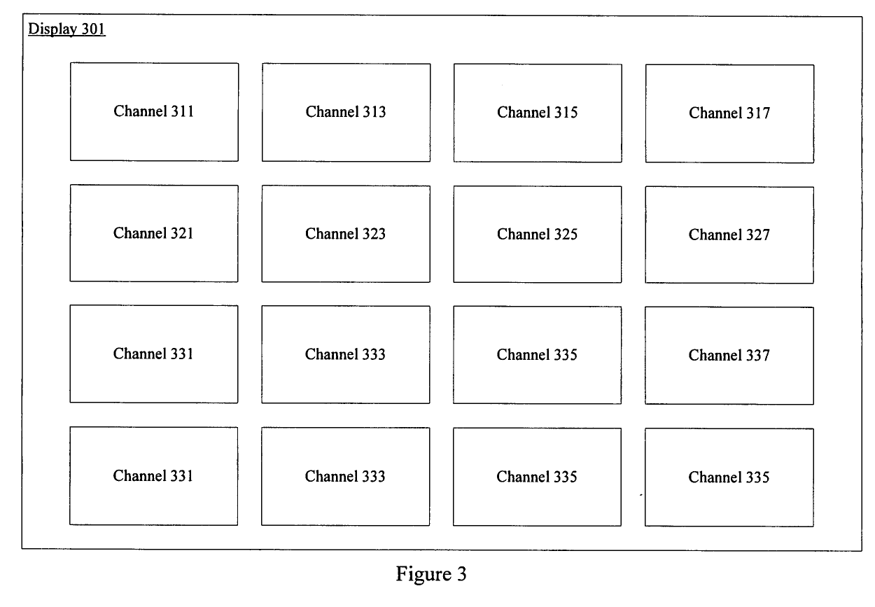

FIG. 3 illustrates a particular example of a mosaic video stream. According to particular embodiments, a display 301 is configured to show a mosaic video stream providing multiple video streams including channels 311-335. With a mosaic video stream, a user can view video streams for channels 311-335 using a single channel feed on a single channel. Each channel may show live or video clip content. According to particular embodiments, a mosaic video stream shown on a display 301 is not generated by an end device receiving multiple video streams and aggregating the streams onto a single display. Although this may be possible, this would consume a large amount of bandwidth and processing resources. Some devices do not have the ability to render multiple video feeds. According to particular embodiments, the mosaic video stream is generated by a server associated with a content or service provider. The content or service provider provides multiple video streams to an end user by aggregating them onto a single channel.

In particular examples, the content or service provider has the ability to generate mosaic video streams providing live or looped content for multiple channels in a visual pattern for viewing on a display 301. Navigation mapping information can also be provided to allow selection of a channel by a user. According to particular embodiments, the mosaic video stream is provided with a listing of channels and coordinate information corresponding to the position of the channel window in the mosaic video stream. For example, channel 311 may be provided with a pair of coordinates, four coordinates, a coordinate and a size, etc. A variety of position information can be sent to a device to allow a device to provide an appropriate overlay for video content selection.

The video content for a mosaic video stream can be selected using a variety of criteria. According to particular embodiments, the real-time most popular video content is selected for inclusion in a mosaic video stream. Real-time viewership information can be used to order channels based on popularity. In particular examples, video content may include channels for a particular category or type of video content. In still other particular embodiments, video content may be selected based on ratings or user selection. For example, a user may select particular channels for a personalized mosaic video stream that a content provider or service provider generates for the user.

According to particular embodiments, a provider generates numerous mosaic video streams based on various criteria. The mosaic video streams may each have their own navigation mapping to allow a user to select video content using a device provided overlay. The mosaic video stream may also show multiple live and clip feeds in a variety of visual arrangements.

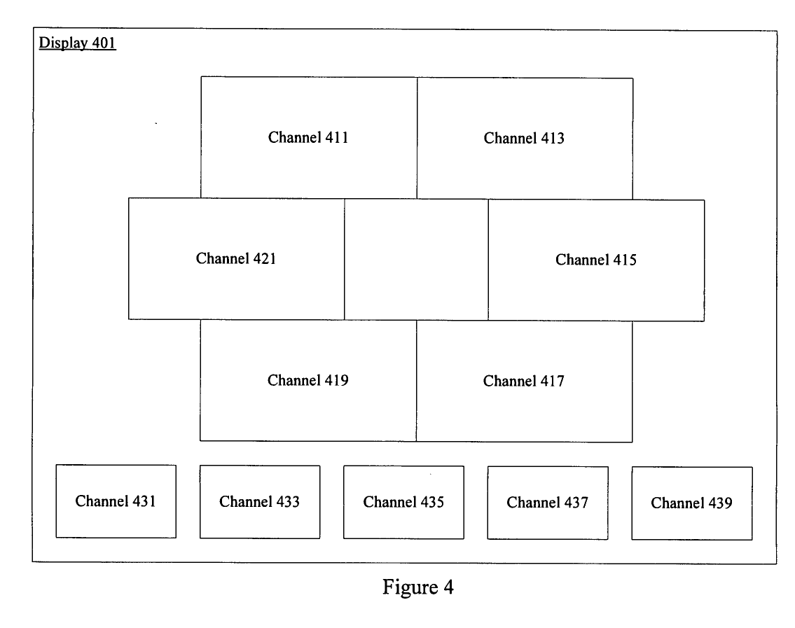

FIG. 4 illustrates another example of a mosaic video stream. The display 401 shows channels 411, 413, 415, 417, 419, and 421 in a circular arrangement with other channels 431, 433, 435, 437, and 439 listed as auxiliary channels at the bottom of a display 401. A variety of arrangements are possible. The mosaic video stream provides navigation mapping information to a device. According to various embodiments, the channel listing for the mosaic video stream is provided with position information indicating where the video streams for each channel are located in the mosaic video stream display.

According to particular embodiments, the video streams provided in each channel window change with time. A provider may alternate between movie channels and sports channels aggregated in a mosaic video stream. Alternatively, real time most popular content may be shifted into a more prominent position. According to particular embodiments, a device provides an overlay for a mosaic video stream to allow a user to select content. Navigating to another mosaic view or to a particular part of a mosaic view in order to zoom or change view entails a channel change. In particular examples, the overlays allow interaction where mosaic patterns associated with a mosaic video stream do not.

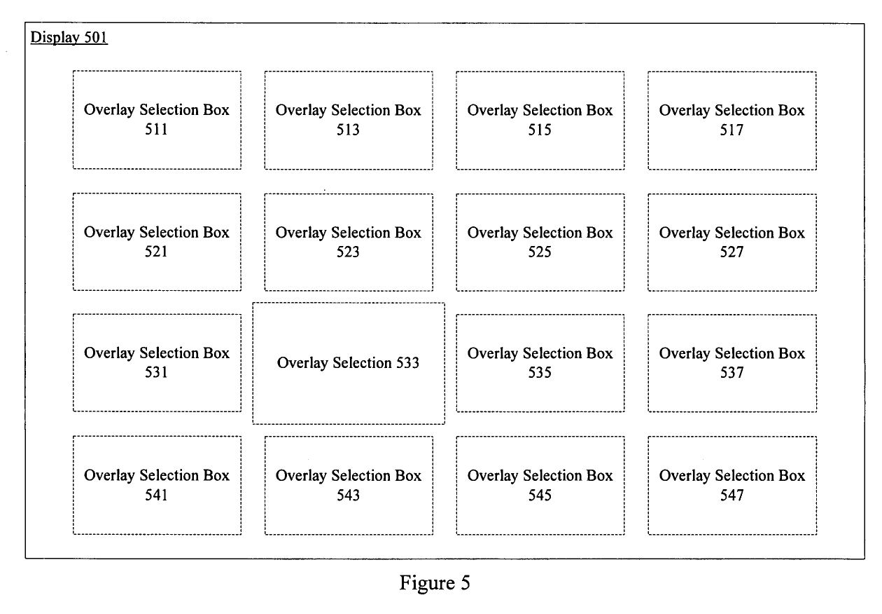

FIG. 5 illustrates a particular example of an overlay. According to particular embodiments, a client side application provides overlays corresponding to particular mosaic video streams. Overlays may be partially or completely transparent, allowing a user to interact with a mosaic view. Overlays may be generated or predefined. In particular examples, a device receives mapping information from a provider and shows a display 501 with overlay selection boxes 511-555. According to particular embodiments, a user navigates the overlay selection boxes and selects video content by identifying a particular overlay selection such as overlay selection 555. The overlay selection boxes may be arranged in a variety of visual patterns corresponding to mosaic video streams. In particular examples, an overlay selection 555 highlights a particular video channel when selected. Selecting the channel in overlay selection 533 results in a channel change to allow viewing of the corresponding video content. According to particular embodiments, the overlay has the ability to support customized advertising on channels.

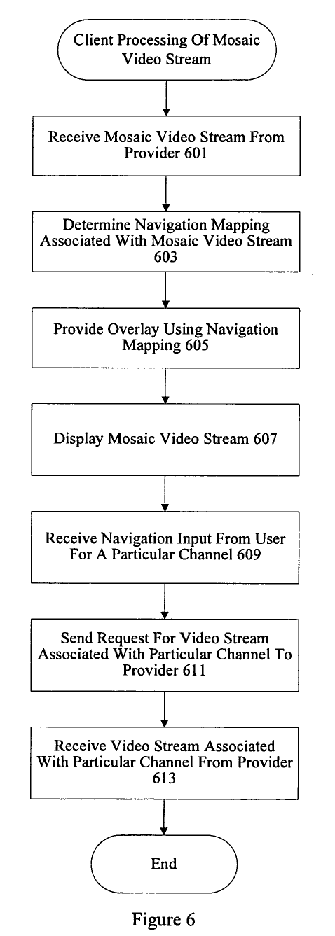

FIG. 6 is a flow process diagram showing one example of a technique for client processing of a mosaic video stream. At 601, a mosaic video stream is received from a provider. According to particular embodiments, a service provider or content provider transmits numerous channels with mosaic video streams. In particular examples, a mosaic video stream showing multiple channels is provided on a single channel. Some mosaic video stream channels may show streams for a particular category of content. A user can elect to receive a particular mosaic video stream. At 603, a client device determines navigation mapping information associated with a mosaic video stream. In particular examples, the navigation mapping is a list of channels and corresponding coordinates. In other examples, the navigation mapping is a template with particular associated video clips. The navigation mapping may be transmitted with a mosaic video stream or may be provided separately. At 605, a device provides an overlay using the navigation mapping information. At 607, a mosaic video stream 607 is displayed with the overlay. The overlay allows a user the ability to select channels without the mosaic video stream having to be interactive. Receiving a mosaic video stream from a provider also frees a device from having to aggregate or render multiple video streams from separate channels.

At 609, a device receives navigation input from a user for a particular channel. The navigation input may be a selection using the overlay of a particular position corresponding to a particular channel. Alternatively, navigation input may be text or numeric entries identifying a particular channel in the mosaic video stream. At 611, the overlay allows a device to send a request for a selected video stream to a provider. At 613, a selected video stream associated with a particular channel is received from a provider.

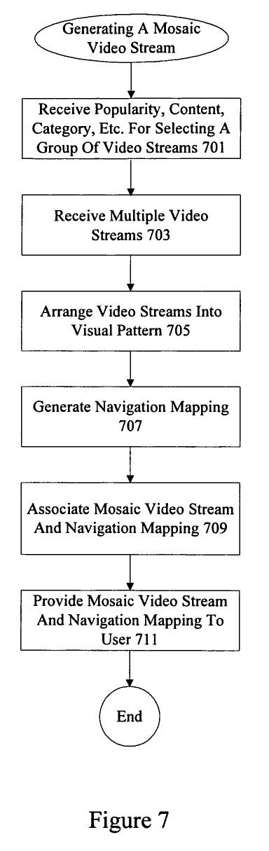

FIG. 7 illustrates one particular example of server processing for generating a mosaic video stream. At 701, a server receives popularity, content, category information etc for selecting a group of video streams for inclusion in mosaic video stream. At 703, the server receives multiple video streams. At 705, the video streams are arranged into a visual pattern. At 707, navigation mapping information is generated. At 709, a mosaic video stream is associated with the navigation mapping. At 711, the mosaic video stream and navigation mapping is provided to a user.

While the invention has been particularly shown and described with reference to specific embodiments thereof, it will be understood by those skilled in the art that changes in the form and details of the disclosed embodiments may be made without departing from the spirit or scope of the invention. It is therefore intended that the invention be interpreted to include all variations and equivalents that fall within the true spirit and scope of the present invention.

Because such information and program instructions may be employed to implement the systems/methods described herein, the present invention relates to tangible, machine readable media that include program instructions, state information, etc. for performing various operations described herein. Examples of machine-readable media include hard disks, floppy disks, magnetic tape, optical media such as CD-ROM disks and DVDs; magneto-optical media such as optical disks, and hardware devices that are specially configured to store and perform program instructions, such as read-only memory devices (ROM) and programmable read-only memory devices (PROMs). Examples of program instructions include both machine code, such as produced by a compiler, and files containing higher level code that may be executed by the computer using an interpreter.

Although many of the components and processes are described above in the singular for convenience, it will be appreciated by one of skill in the art that multiple components and repeated processes can also be used to practice the techniques of the present invention.

While the invention has been particularly shown and described with reference to specific embodiments thereof, it will be understood by those skilled in the art that changes in the form and details of the disclosed embodiments may be made without departing from the spirit or scope of the invention. It is therefore intended that the invention be interpreted to include all variations and equivalents that fall within the true spirit and scope of the present invention.

What is claimed is:

1. A method, comprising:
receiving a first mosaic video stream at a device;
displaying the first mosaic video stream to a user, the first mosaic video stream presenting a plurality of streaming channels;
providing a first overlay corresponding to the first mosaic video stream to the user, the first overlay allowing selection of a first streaming channel in the plurality of streaming channels;
receiving a user selection for the first streaming channel on the first overlay;
receiving the first streaming channel at the device;
displaying the first streaming channel to the user.

2. The method of claim 1, wherein the first mosaic video stream further presents a plurality of video clips.

3. The method of claim 2, wherein the plurality of streaming channels and the plurality of video clips are displayed in a grid format.

4. The method of claim 2, wherein the plurality of streaming channels and the plurality of video clips are displayed in a circular format.

5. The method of claim 1, wherein the first mosaic video stream is a single streaming channel.

6. The method of claim 1, wherein the first overlay allows numeric/text based entry.

7. The method of claim 1, wherein the first overlay allows graphical user interface selection of the first streaming channel.

8. The method of claim 1, further comprising receiving a second mosaic video stream.

9. The method of claim 8, providing a second overlay corresponding to the second mosaic video stream.

10. A device, comprising:
an interface operable to receive a first mosaic video stream;
a display operable to output the first mosaic video stream to a user, the first mosaic video stream presenting a plurality of streaming channels;
a processor operable to generate a first overlay corresponding to the first mosaic video stream to the user, the first overlay allowing selection of a first streaming channel in the plurality of streaming channels;
wherein the processor is further operable to identify a user selection for the first streaming channel on the first overlay and process the first streaming channel for output to the user.

11. The device of claim 10, wherein the first mosaic video stream further presents a plurality of video clips.

12. The device of claim 11, wherein the plurality of streaming channels and the plurality of video clips are displayed in a grid format.

13. The device of claim 11, wherein the plurality of streaming channels and the plurality of video clips are displayed in a circular format.

14. The device of claim 10, wherein the first mosaic video stream is a single streaming channel.

15. The device of claim 10, wherein the first overlay allows numeric/text based entry.

16. The device of claim 10, wherein the first overlay allows graphical user interface selection of the first streaming channel.

17. The device of claim 10, further comprising receiving a second mosaic video stream.

18. The method of claim 17, providing a second overlay corresponding to the second mosaic video stream.

19. An apparatus, comprising:
means for receiving a first mosaic video stream;
means for displaying the first mosaic video stream to a user, the first mosaic video stream presenting a plurality of streaming channels;
means for providing a first overlay corresponding to the first mosaic video stream to the user, the first overlay allowing selection of a first streaming channel in the plurality of streaming channels;
means for receiving a user selection for the first streaming channel on the first overlay;
means for receiving the first streaming channel at the device;
means for displaying the first streaming channel to the user.

20. The apparatus of claim 19, wherein the first mosaic video stream further presents a plurality of video clips.
